(19) United States
(12) Patent Application Publication
(10) Pub. No.: US 2002/0113879 A1
(43) Pub. Date: Aug. 22, 2002

(54) Automatic camera method, apparatus and service

(76) Inventors: Steven Andrew Battle, Horfield Bristol (GB); Alex Roche, Barcelona (ES); Anthony J. Wiley, Stoke Bristol (GB); Manuel Gonzalez, Barcelona (ES); Jeremy John Carroll, Bristol (GB)

Correspondence Address: HEWLETT-PACKARD COMPANY, Intellectual Property Administration, P. O. Box 272400, Fort Collins, CO, 80527-2400, US

(21) Appl. No.: 10/056,118

(22) Filed: Jan. 28, 2002

(30) Foreign Application Priority Data
Jan. 31, 2001 (GB) 0102421.5

(51) Int. Cl. H04N 7/00; H04N 11/00

(52) U.S. Cl. 348/207.2; 348/231.3; 348/552

(57) ABSTRACT

A digital photographic image service process comprises registration of a user data including user name, address and financial account details; capture of photographic image data in response to an activation signal generated by and/or authorized by said user; forwarding of said additional image data to an photographic e-service provider responsible for fulfilment of an order for delivery of said photographic image data, or physical prints generated therefrom; and collection of payment, by electronic means.

### FIELD OF THE INVENTION

The present invention relates to the field of photography.

### BACKGROUND OF THE INVENTION

Conventional, photography products and services aimed at the consumer include;

Conventional film based or digital hand held still frame or video/film camera technology commercially available as mass market consumer goods.

Photography services provided by small businesses, for example professional photographers attending special occasions such as weddings or religious events, or providing studio based photography services aimed at family photography services;

Photo booths, containing automatic photographic equipment activated by a customer inserting coins, and sitting or standing in a confined enclosed cubicle at a predetermined distance from a fixed mounted camera equipment, having an automatic film processing system, and used to take, for example, passport sized photographs.

The above constitute prior art known markets for photography based products and services aimed at consumers.

Each of the above products or services has its own specific features and advantages. However, for the general public, the above known scenarios have the following omissions or disadvantages:

In the case of conventional mass market consumer camera and video equipment, there is significant cost of ownership of cameras and video equipment for the individual consumer. Individuals do not always carry camera or video equipment around with them, and photo opportunities may arise where individuals do not have their camera or video equipment with them.

Conventional consumer camera and video equipment generally requires an operator to activate taking of photographs by pointing the camera at a scene, and activating the camera or video equipment. Some conventional cameras and video equipment have automatic features, such as timers, which enables operation in operator-free mode, under limited circumstances. However, in many scenarios, for example in the case of a family outing, it is often not possible to capture family activity scenes, without an operator of a camera or video equipment. Since one likely scenario is that the operator will be a member of a family subject of a photograph, this restricts the photography or video film recording of family groups, since one family member is generally operating the photographic equipment

Known photo booths, due to their relatively compact size, have obvious limitations in photography of family group scenes, or photography of individuals except in very limited circumstances, due to the physical size and enclosed nature of the booth.

### SUMMARY OF THE INVENTION

Specific implementations according to the present invention provide an automatic camera facility mounted in a fixed location, and offering an integrated photography service. Digital photographs are taken and may be retrieved immediately or later at a same location where the photograph is taken, or at a remote location.

Photographs are taken in response to a user generated stimulus, for example a proximity sensor, automatically detecting the presence of a subject in a field of view, or by a hand held transmitter activated by a person within a field of view of the camera, or by a physical switch placed at a camera installation, which is activatable by a person within a field of view of the camera.

A field of view of the camera contains a scene, and is not restricted to a small booth. A camera installation may be deployed inside a building in a room, or outdoors.

According to a first aspect of the present invention there is provided a camera installation comprising:

a camera capable of taking a photographic image data capturing an image over a field area of a size capable of containing a plurality of human individuals;

a user portable activation device for activating said camera device to capture a said photographic image data, said activation device carrying a unique identifier data for identifying said user; and

a data entry device capable of receiving data identifying a user of the camera installation, the data entry device being provided in close physical proximity to said camera device.

According to a second aspect of the present invention there is provided a photographic service system comprising:

at least one camera installation for capturing photographic digital image data in response to an input signal generated by a person; personal details of a user and receive delivery address data specifying a delivery destination for delivery of a photographic product;

said service provider computer entity configured to:

send said photographic image data to a destination specified by said delivery address data.

According to a third aspect of the present invention there is provided a method of providing photographic images to a user specified destination, said method comprising the processes of:

collecting electronic user registration data, describing a name and address of a user person;

collecting destination data specifying a delivery destination of an image;

generating photograph image data of a field of view, in response to an input signal generated by an individual person; and

delivering a said image to a destination specified by said delivery destination data;

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a camera installation in perspective view, according to a first specific embodiment of the present invention;

FIG. 2 illustrates schematically components of the camera installation of FIG. 1;

FIG. 3 illustrates schematically an overall system layout for a photographic system according to a specific implementation of the present invention; and

FIG. 4 illustrates schematically a logical architecture of the photographic system of FIG. 3.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

According to one specific implementation of the present invention, automatic camera facilities are located in one or a plurality of locations, and offer an integrated photography service, providing digital photographs which may be stored locally at a site where a photograph is taken, and retrieved at a remote location. Photograph image data may be offered to individual humans who appear in the photographs, and who may be registered with a photography registration service prior or subsequent to a photograph being taken.

Photographs may be taken either when an individual moves into range of a camera, identified by a proximity sensor or tracking device, or in response to an individual person activating a photograph. The tracking device or proximity sensor may include devices such as radio tags, a global positioning system (GPS) transmitter, or a face recognition device.

A particular individual or group of individuals may be within a photographic area for an extended period of time. Software packages may be applied to select the best (clearest, best defined) photographs, available from a plurality of photographs taken.

Photographic systems according to the specific implementations of the present invention may find application in public places, and public attractions, for example theme parks, where cameras can be mounted at or near main attractions, for example on a theme park rides.

The specific implementations according to the present invention may provide a photographic service which is specifically aimed at a subject individual appearing in a photograph.

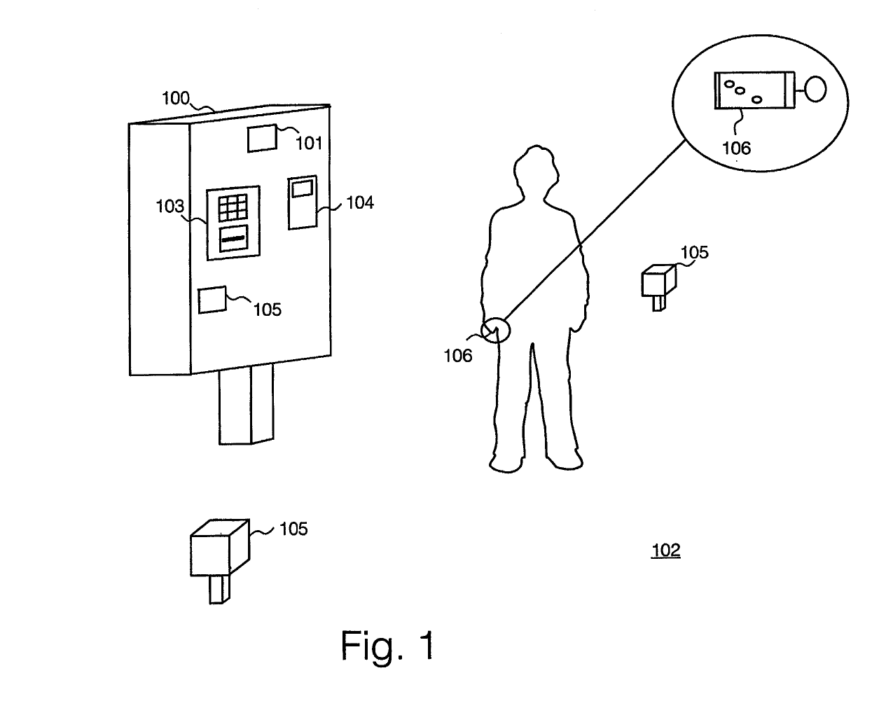

Referring to FIG. 1 herein, in one embodiment, a camera installation comprises a casing 100 having an aperture 101 through which a digital camera has a view into a field of view 102, external of the casing 100; a data input device 103, which may include for example a keypad, smart card reader, or transceiver device; and a display 104, which may comprise for example a liquid crystal display, video monitor or the like, for displaying information and menus for activating the taking of digital photographs; one or more sensors 105, which may include proximity sensors, motion detection sensors, and/or position sensors; and a hand held transmitter device 106 being user activatable, for initiating a transfer of personal user data to the camera installation, and activating taking on a digital photograph. The sensors 105 may be mounted within the casing 100, or deployed around the field of view 102.

Suitably, the camera installation may be enclosed in a weather proof, freestanding casing, such that the camera installation may be installed outdoors, without the need for any external supporting structure e.g. a wall or the like. In other embodiments, the casing may be adapted for wall mounting, or for mounting inside a building, where extreme weather conditions will not be experienced.

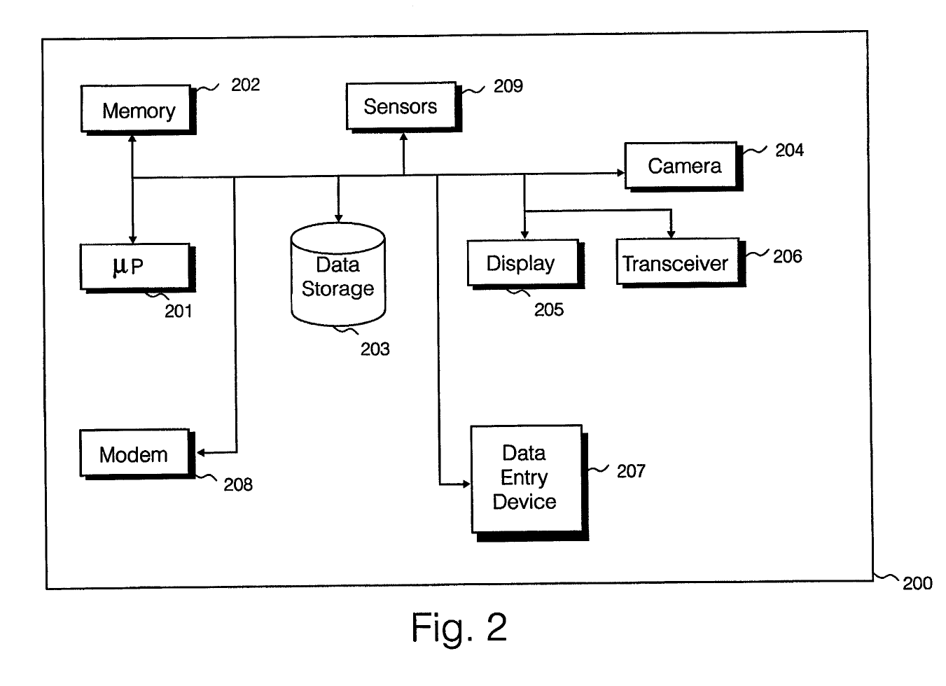

Referring to FIG. 2 herein, there is illustrated schematically hardware components of the camera installation 100 shown in FIG. 1. The camera installation comprises a data processor 201, of known type, e.g. an Intel Pentium®, or similar; associated memory 202 as is known in the art; a data storage device 203, for example a hard disk drive, capable of storing digital photographic image data; a digital camera 204 capable of generating digital photographic image data (the digital camera including in some variants a digital video recorder); a display device 205 for displaying status messages, and user menus to a user; optionally, a transceiver 206, activatable by a transmitter device carried by a user; a data entry device 207, including for example a keypad, a smart card reader or the like as is known in the art, for inputting details of a user, subject of a photograph captured as digital photograph data by the camera 204; a modem 208 for connecting with a communications network; a plurality of proximity sensors 209, for detecting when a human is in a field of view, the proximity sensors being selected from infra red sensors, laser beam sensors, ultra sonic detection sensors, fiber optic sensors or any other suitable sensor type for detecting when a person is in a predefined area or region; and a data bus 210 allowing communication between the components.

The user may carry a known palm-top computer entity, for example a Palm Pilot® type device, specifically configured to transmit user registration data to the camera installation via the transceiver 206, and in return receive digital image data which may be stored within the hand held computer entity for transfer to a further computer entity, for example a personal computer or the like, at a later time, whereupon digital photograph images may be printed by a print mechanism of the further computer. The palm computer entity may also store the user's account data, which is transmitted to the camera installation, allowing account data collection as well as user registration data collection in one operation. A user may type into their hand held computer entity device a destination address to which the photographic images or image data is to be sent, which may also be transmitted to the camera installation whilst the user is in the field of view. Storage of the user registration data, user account data, and a menu for entering destination address details may be managed by a custom written application loaded into the palm held computer entity.

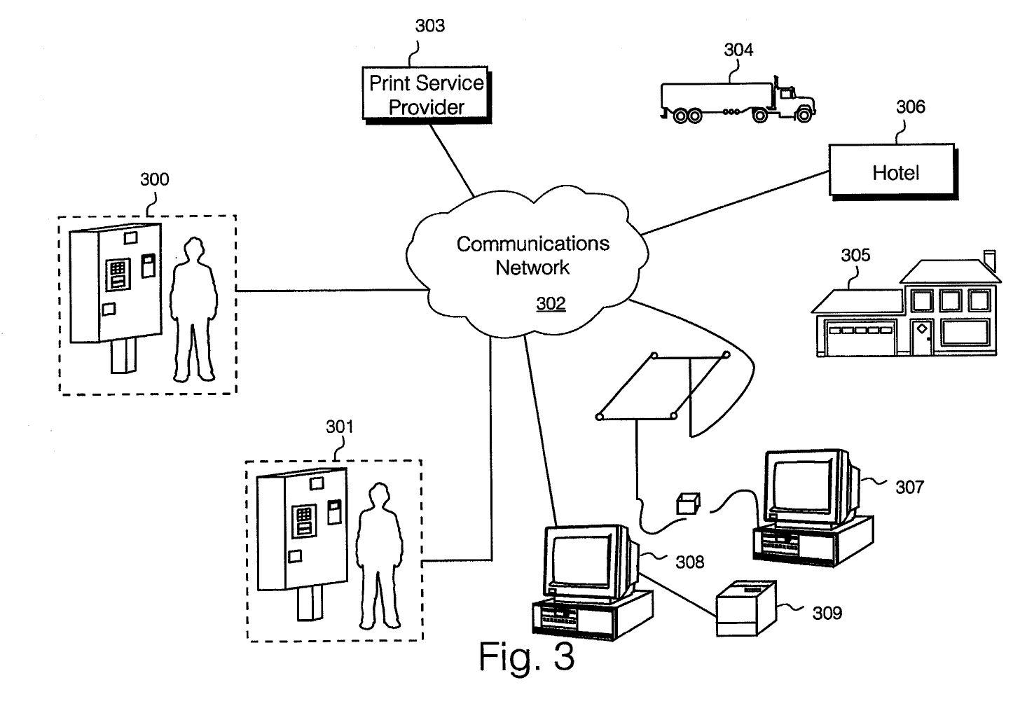

Referring to FIG. 3 herein, there is illustrated schematically an overall system layout for a photographic service, according to a specific implementation of the present invention. The service is based around a plurality of camera installations as illustrated with reference to FIGS. 1 and 2 herein, 300, 301. Installations may be deployed at a customer site, for example a theme park. Each individual camera installation is connected to a communications network 302, which may be the internet, a virtual private network, or the like. In addition to a plurality of camera installations, the system comprises one or more print service providers 303, having physical delivery service, for example the normal mail service 304, for delivery of physical photographic prints to one or more destination addresses 305 specified by one or more customers of the service; a registration facility for registering a user with the service, for example provided by a hotel check in service at a hotel 306, or via an internet enabled computer terminal 307, for example a PC with modem, capable of communicating via the print service provider 303 over the internet, or via the data entry device on the camera installations.

Network connected computer entities 308, having a printer device 309 may receive photographic image data from the print service provider 303 via the communications network 302 as an e-service. Users of the service, being individual customers or persons, register with the service by providing input data describing details including; user name; user address; address for delivery of physical photographic prints; payment details, for example credit card, bank account number or direct debit authorization of the user; one or more electronic delivery addresses, for example an email address; recipient individual name details of a recipient person of the prints.

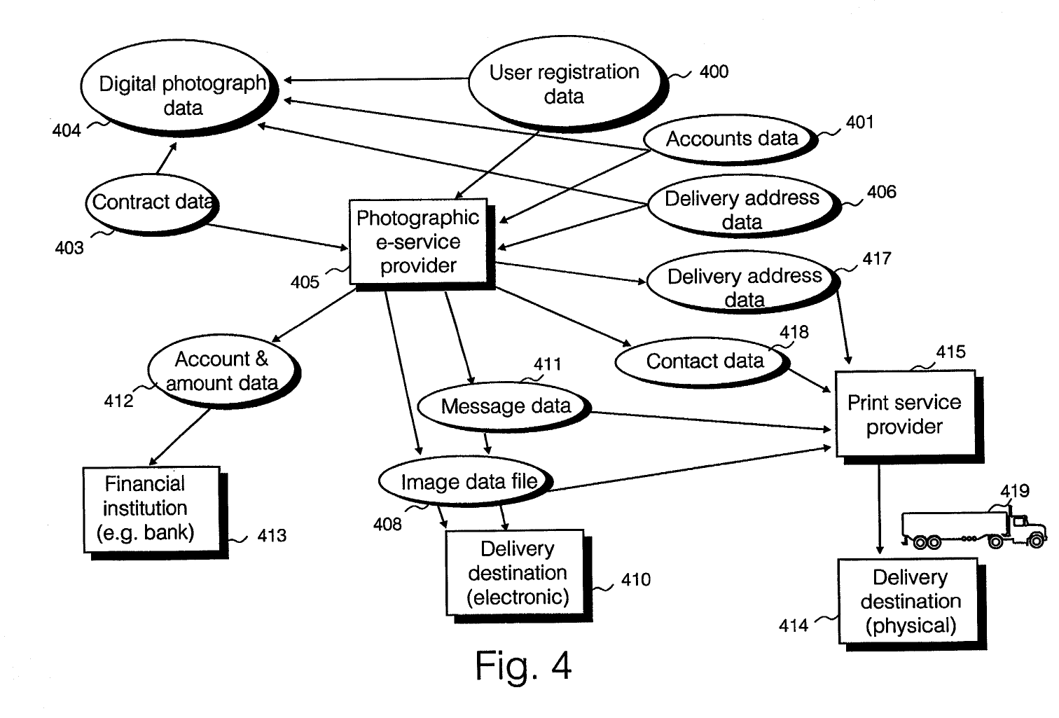

Referring to FIG. 4 herein, there is illustrated schematically a logical architecture and data flow diagram of a photographic service system enabled by the camera installation described herein with reference to FIGS. 1 and 2.

A user inputs registration data 400 into the system including personal name data, and address data by any one of the variety of data entry mechanisms which may include: direct entry of data in to the camera installation via data entry device 207; pre-registration of data via an internet enabled computer entity 307; transfer of user registration data from a hotel check in system at a hotel 306. The user also enters account data 401 describing bank account details, credit card details, or the like by a similar mechanism as used to enter the registration data 400. Digital photograph data 402 is generated by the camera installation and comprises a photograph of an image, in which a user, or a person associated with the user, for example a close family relative, appears. Capture of the image data is as previously described with reference to FIGS. 1 and 2 herein and may be sensor activated, or activated by the user via a transmitter device or by pressing a button on the photographic installation itself. A contract data 403 constitutes data which establishes a legal contract for the supply of photographic images either in physical or electronic form. The contract data may be created automatically, for example by pressing a “take photo” button activating taking of a photograph at the camera installation itself. The action of taking a photograph creates a contract, according to a pre arranged agreement format. The agreement format may, for example be displayed on a web site of a photographic e-service provider 405, and entered into by the customer, before any photographs are taken, or be displayed as printed information at a hotel check in and registration facility. Data may be entered via a hotel check in facility, for example in the environment of a theme park, as part of the overall package for a stay at the theme park.

Delivery address data 406 specifies a delivery address to which physical and/or electronic photograph images are to be delivered. Delivery address data may be entered by any suitable mechanism, including for example entry of the delivery address data via a data entry device 207, allowing a user to check the data via a display 205 at the photographic installation, or by a user terminal provided in a hotel room.

The photographic service operates as follows.

Photographic e-service provider 405 receives user registration data 400, user account data 401, delivery address data 406 specifying one or more physical and/or electronic addresses for delivery of photographic image data, together with a recipients name, and optionally a personalized message entered by a user; digital photograph data 404 from the camera installation; and contract data 403 establishing a contract with the user of the service.

Having taken a plurality of photographic images at the camera installation, digital image data may be sent via the communications network 302 to the print service provider 303. The print service provider 303 may display upon a web site, small thumbnail sized images of a person in the environment of the camera installation. For example a user may visit the web site from a remote computer entity, view thumbnail images of the user or the users relatives, in particular environment, for example a theme park ride, and download those images to their own computer entity for local printing, subject to registration data of the user, delivery destination details and account data of the user having been entered into the system, either via the web site, or through any other of the mechanisms described herein.

The photographic e-service provider 405 processes the received data in order to deliver the contracted photographic service, that is the delivery of electronic or physical photograph images to one or more delivery destinations as specified by the user, and charges the user for that service.

As a separate operation, the e-service provider sends customer account and transaction amount data 412 to a financial institution, for example a bank or financial clearing system 413. Upon receipt of the customer account data and amount data, the financial institution transfers the relevant amount to a bank account held by the service provider from an account held by the user as is known in the prior art.

In the case of delivery of electronic photographic image data direct to an electronic destination specified by a user, the photographic e-service provider 405 assembles a data file, for example a JPEG file, and sends this directly to a specified electronic delivery destination 409, for example a user specified email address. Additionally, the file may be modified to include message data 411 to accompany the digital image data. The message data can be input by a user at the camera installation 301 via data entry device 207, or can be generated automatically from a pre-determined list of standardized messages stored at the photographic e-service provider 405. The image data file, and optionally, message data is received by the electronic destination, for example in the form of an email, and may be read and printed using a prior art, or specially adapted application for reading image files and printing messages.

For delivery of physical photographic prints, the photographic e-service provider must satisfy the order by generation of physical prints and delivery of those physical prints to a physical destination specified by the user. The physical destination is input by the user as delivery address data 406, and may include the name of a friend or relative, and their physical home address, or any other physical address 414 to which the physical prints are to be delivered.

The physical prints are generated by print service provider facility 415. The print service provider may be a separately owned and operated business to the photographic e-service provider 405, or may be part of the same organization. The print service provider receives delivery address data 416, optionally, personal message data 417, and optionally, a second contract data 418, establishing a contract between the photographic e-service provider 405 and the print service provider 415, for producing and delivering the photographic prints; and the image data file(s) 408 of the particular photographic images which are to be delivered. Upon receipt of all the necessary information, the print service provider prints a specified number of photographic prints, either in a predetermined physical size format, or in a size format specified within contract data 418, and makes physical delivery of those prints to the physical destination 414, for example via a third party physical carrier 419.

In the best mode implementation, all transfers of data between the photographic e-service provider 405, the camera installation, the electronic delivery destination 410, and the print service provider 415, and the financial institution 413 are implemented as electronic data files sent over the communications network, preferably the internet. However, in other implementations, parts of the data may be implemented by other prior art messaging systems. For example user registration data 400, account data 401 may be sent as a paper form to the e-service provider 405. For example this data may be entered on a paper printed form issued in a magazine advertisement or the like by the photographic e-service provider 405.

1. A camera installation comprising:
a camera capable of taking a photographic image data capturing an image over a field area of a size capable of containing a plurality of human individuals;
a user portable activation device for activating said camera device to capture a said photographic image data, said activation device carrying a unique identifier data for identifying said user; and
a data entry device capable of receiving data identifying a user of the camera installation, the data entry device being provided in close physical proximity to said camera device.

2. The camera installation as claimed in claim 1, wherein said activation device is configured to automatically activate said camera on entering said field area.

3. The camera installation as claimed in claim 1, wherein said activation device is passively interrogated to read said unique identifier data when in close physical proximity to said data entry device.

4. The camera installation as claimed in claim 1, wherein said activation device is configured to store registration data describing personal details of said user.

5. The camera installation as claimed in claim 1, wherein said activation device is configured to store user financial account data, which is transferable to said data entry device.

6. The camera installation as claimed in claim 1, wherein said activation device comprises a hand held computer entity.

7. The camera installation as claimed in claim 1, wherein said data entry device comprises:
a keypad having a plurality of alphanumeric keys, by which a user may enter text data by activating said alphanumeric keys.

8. The camera installation as claimed in claim 1, wherein said data entry device comprises:
a radio receiver capable of receiving digital data uniquely identifying a user.

9. The camera installation as claimed in claim 1, further comprising a visual display device, said visual display device displaying an operation menu, configured to prompt a user to understand operation of said camera installation.

10. The camera installation as claimed in claim 1, wherein said camera installation is enclosed in a weather proof casing, for outdoor use.

11. The camera installation as claimed in claim 1, comprising a self supporting casing capable of free-standing installation.

12. A photographic service system comprising:
at least one camera installation for capturing photographic digital image data in response to an input signal generated by a person;
at least one service provider computer entity configured to receive said image data from a said camera installation, receive user registration data describing personal details of a user and receive delivery address data specifying a delivery destination for delivery of a photographic product;
said service provider computer entity configured to:
send said photographic image data to a destination specified by said delivery address data.

13. A photographic service system as claimed in claim 12, wherein said at least one service provider computer entity is configured to:
receive user account data describing financial account data of a user;
send said account data to a financial institution for effecting payment of a monetary amount from said user.

14. A method of providing photographic images to a user specified destination, said method comprising the processes of:
collecting electronic user registration data, describing a name and address of a user person;
collecting delivery destination data specifying a delivery destination of an image;
generating photograph image data of a field of view, in response to an input signal generated by an individual person; and
delivering a said image to a destination specified by said delivery destination data.

15. The method as claimed in claim 14, further comprising the processes of:
collecting electronic account data describing a financial account of said user person; and
using said electronic account data and electronic user registration data to collect payment for said processes of generating and delivering said image.

16. The method as claimed in claim 14, wherein said process of delivering said image comprises:
delivering an electronic image data file to a specified electronic said delivery destination.

17. The method as claimed in claim 14, wherein said process of delivering said image comprises:
transmitting said photographic image data between first and second computer entities as electronic data;
at said second computer entity, converting said photographic image data into a physical photographic print;
physically delivering said physical photographic print to a physical said delivery destination.

18. The method as claimed in claim 14, further comprising the step of:
sending said electronic account data describing an account details of a said user, to a third party computer entity; and
collecting a payment from said third party computer entity.

19. The method as claimed in claim 14, wherein said photograph image data is generated in response to an input signal received in close physical proximity to a site of capture of said photograph image data.

20. The method as claimed in claim 14, wherein said steps of collecting electronic user registration data, collecting electronic account data, and collecting delivery destination data comprises:
transmitting said electronic user registration data, electronic account data and delivery destination data from a hand held computer entity device held by said user, to a camera installation comprising a camera which generates said photograph image data.

21. The method as claimed in claim 14, wherein a photographic image comprises a sequence of video images.

22. The method as claimed in claim 14, further comprising the processes of:
collecting personalised message data from said user; and
delivering a message contained in said message data, to said delivery destination, together with said image.

23. The method as claimed in claim 14, further comprising the process of:
displaying a photographic image data on a web site.

24. The method as claimed in claim 14, further comprising the steps of:
displaying a photographic image data on a web site; and
downloading a said photographic image from said web site to a remote computer entity.

25. A method of providing photographic images to a user specified destination, said method comprising the processes of:
collecting electronic user registration data, describing a name and address of a user person;
collecting delivery destination data specifying a delivery destination of an image;
generating photograph image data of a field of view, in response to an input signal generated by an individual person wherein said photograph image data is generated in response to an input signal received in close physical proximity to a site of capture of a said photograph image date;
collecting electronic account data describing a financial account of said user person;
using said electronic account data and electronic user registration data to collect payment;
collecting personalized message data; and
delivering a said image, and a said message containing said message data to said delivery destination.

26. A photographic service system comprising:
at least one camera installation for capturing photographic digital image data in response to an input signal;
at least one service provider computer entity configured to electronically receive said image data from a said camera installation, receive user registration data describing personal details of a user and receive delivery address data specifying a delivery destination for delivery of a photographic product;
said service provider computer entity configured to:
send said photographic image data to a destination specified by said delivery address data;
receive user account data describing financial account data of a user;
said camera installation comprising:
a camera capable of taking photographic image data capturing an image over a field area of a size capable of containing a plurality of human individuals;
a user portable activation device for activating said camera device to capture a said photographic image data, said activation device carrying a unique identifier data for identifying said user; and
a data entry device capable of receiving data identifying a user of the camera installation, the data entry device being provided in close physical proximity to said camera device.
